(19) United States
(12) Patent Application Publication
(10) Pub. No.: US 2025/0112335 A1
(43) Pub. Date: Apr. 3, 2025

(54) BATTERY MODULE

(71) Applicant: TOYOTA JIDOSHA KABUSHIKI KAISHA, Toyota-shi (JP)

(72) Inventors: Shinya ISHIKAWA, Anjo-shi (JP); Takashi MIURA, Nagoya-shi (JP); Tetsuya MIMURA, Chiryu-shi (JP); Toshihiro SHIMONAKA, Toyota-shi (JP); Yuki HIRATA, Chigasaki-shi (JP); Masayoshi HAGA, Nagoya-shi (JP); Kazuya KUMAZAWA, Nagoya-shi (JP)

(21) Appl. No.: 18/896,955

(22) Filed: Sep. 26, 2024

(30) Foreign Application Priority Data
Sep. 29, 2023 (JP) 2023-170856

(51) Int. Cl. H01M 50/503; B60L 50/64; H01M 50/105; H01M 50/178; H01M 50/211; H01M 50/507; H01M 50/512

(52) U.S. Cl. CPC H01M 50/503; H01M 50/105; H01M 50/178; H01M 50/211; H01M 50/507; H01M 50/512; B60L 50/64; H01M 2220/20

(57) ABSTRACT

A battery module in which plural battery cells that are laminated to each other are accommodated inside a module case, and the plural battery cells are electrically connected to each other, wherein: each battery cell includes a first side surface portion that is an embossed surface forming a housing space at an interior of the battery cell, and a planar second side surface portion, which are arranged so as to face each other in a lamination direction, and an electrode lead is provided along the second side surface portion and protrudes from width direction end portions of the battery cell, and the battery module includes at least one first connection portion that arranges second side surface portions of two adjacent battery cells so as to face each other, brings electrode leads of the two adjacent battery cells close to each other, and is connected to the bus bar.

### CROSS-REFERENCE TO RELATED APPLICATION

This application is based on and claims priority under 35 USC 119 from Japanese Patent Application No. 2023-170856, filed on Sep. 29, 2023, the entire disclosure of which is incorporated by reference herein.

### BACKGROUND

### Technical Field

The present disclosure relates to a battery module.

### Related Art

In the battery module described in Japanese Patent Application Laid-Open (JP-A) No. 2022-109732, plural laminated battery cells and plural bus bars, which electrically connect the plural battery cells to each other, are accommodated in a housing.

In this battery module, the tips of electrode tabs pulled out from the plural battery cells are connected so as to be laminated on one surface of a bus bar to which they are connected.

In the battery module described in Japanese Patent Application Laid-Open (JP-A) No. 2022-109732, plural battery cells are laminated in the same orientation. For this reason, plural electrode tabs are pulled out at intervals in the lamination direction, and are bent toward the bus bar to which they are connected.

In a case in which the length of the bus bar is shortened in the lamination direction in order to increase the space efficiency in the housing, the bending angle of the electrode tabs becomes large in a battery cell that is far from the bus bar, and there is a possibility that the stress load on the electrode tabs becomes large in the connection portion between the electrode tabs and the bus bar due to the expansion of the battery cell generated during swelling of the battery module.

### SUMMARY

In view of the above, an object of the present disclosure is to provide a battery module capable of reducing a stress load on an electrode lead at a connection portion between the electrode lead and a bus bar while increasing the space efficiency in a module case.

A battery module of a first aspect is a battery module in which plural battery cells that are laminated to each other are accommodated inside a module case, and the plural battery cells are electrically connected to each other via a bus bar, wherein: each battery cell includes a first side surface portion that is an embossed surface forming a housing space at an interior of the battery cell, and a planar second side surface portion, which are arranged so as to face each other in a lamination direction, and an electrode lead is provided along the second side surface portion and protrudes from width direction end portions of the battery cell; and the battery module includes at least one first connection portion that arranges second side surface portions of two adjacent battery cells so as to face each other, brings electrode leads of the two adjacent battery cells close to each other, and is connected to the bus bar.

In the battery module of the first aspect, plural battery cells that are laminated to each other are accommodated in the module case. Further, the plural battery cells are electrically connected to each other via a bus bar. Each battery cell includes a first side surface portion that is an embossed surface forming a housing space at an interior of the battery cell, and a planar second side surface portion, which are arranged so as to face each other in a lamination direction, and has a so-called single-cup embossing structure. Further, each battery cell includes an electrode lead that is provided along the second side surface portion and protrudes from width direction end portions of the battery cell.

Here, the battery module includes a first connection portion that arranges second side surface portions of two adjacent battery cells so as to face each other, brings electrode leads of the two adjacent battery cells close to each other, and is connected to the bus bar. In the first connection portion, even in a case in which the electrode leads of adjacent battery cells are brought into close proximity and the length of the bus bar is shortened in the lamination direction of the plural battery cells, the bending angle of the electrode leads toward a bus bar side, to which the electrode leads connect, can be reduced, whereby a stress load on electrode tabs is reduced. As a result, the bus bar can be shortened, and the space efficiency in the module case can be increased, and the stress load on the electrode leads can be reduced at the connection portions between the electrode tabs and the bus bar.

A battery module of a second aspect is the battery module of the first aspect, wherein the at least one first connection portion brings electrode leads having a same electrical polarity close to each other and electrically connects the two adjacent battery cells in parallel.

In the battery module of the second aspect, the at least one first connection portion electrically connects electrode leads having a same electrical polarity. That is, adjacent battery cells are electrically connected in parallel via the first connection portion. For this reason, at the location at which the plural adjacent battery cells are electrically connected to each other in parallel, the bus bar can be shortened, and the stress load on the electrode lead can be reduced at the connection portion between the electrode lead and the bus bar while increasing the space efficiency in the module case.

A battery module of a third aspect is the battery module of the first aspect or the second aspect, wherein: the battery module includes at least one second connection portion that electrically connects two first connection portions in series via the bus bar, and between a battery cell that is connected to one of the two first connection portions and a battery cell that is connected to another of the two first connection portions, the two adjacent battery cells are arranged such that first side surface portions face each other.

The battery module of the third aspect includes a second connection portion that electrically connects two first connection portions in series via the bus bar. Further, between a battery cell that is connected to one of the two first connection portions and a battery cell that is connected to another of the two first connection portions, the two adjacent battery cells are arranged such that first side surface portions, which are embossed surfaces, face each other. For this reason, a space is provided between the two first connection portions in accordance with the thickness of the embossed surfaces of the two adjacent battery cells. For this reason, the length of the bus bar configuring the second connection portion can be designed in accordance with the thickness of the embossed surfaces of the two adjacent battery cells, whereby design can be facilitated.

A battery module of a fourth aspect is the battery module of the first aspect or the second aspect, wherein the electrode lead protrudes from a height direction central portion of the battery cell.

In the battery module of the fourth aspect, the electrode lead of each battery cell protrudes from width direction end portions of the battery cell, at a height direction central portion of the battery cell. For this reason, even in a case in which the orientation of the battery cell is such that the left and right sides in the width direction are reversed, and even in a case in which the orientation of the battery cell is such that the upper and lower sides in the height direction are reversed, the position of the electrode lead in the module case does not change. As a result, for example, in a case in which two electrode leads having different electrical polarities are brought close to each other and are connected to the bus bar, a direction of one of the two adjacent battery cells may be reversed to the left and right in the width direction, and the second side surface portions of the two adjacent battery cells may face each other. Further, for example, in a case in which two electrode leads having the same electrical polarity are brought close to each other and are connected to the bus bar, a direction of one of the two adjacent battery cells may be reversed vertically in the height direction, and the second side surface portions of the two adjacent battery cells may face each other. In other words, in the fourth aspect, the direction of the battery cells can be freely changed in the module case, whereby the plural battery cells can be connected to each other in a manner with high space efficiency. As a result, the battery module has a highly versatile structure, and design modification thereof in consideration of the space efficiency in the module case is easy.

As described above, in the battery module according to the present disclosure, while increasing the space efficiency in the module case, the stress load on an electrode lead can be reduced at the connection portion between the electrode lead and the bus bar.

### BRIEF DESCRIPTION OF THE DRAWINGS

Exemplary embodiments of the present disclosure will be described in detail based on the following figures, wherein:

FIG. 1 is a schematic plan view illustrating a main part of a vehicle to which a battery pack according to an exemplary embodiment is applied;

FIG. 2 is a schematic perspective view of a battery module according to an exemplary embodiment;

FIG. 3 is a plan view of a battery module according to an exemplary embodiment, in a state in which an upper lid of a module case is removed;

FIG. 4 is a schematic view of a battery cell accommodated in a battery module, as viewed from a thickness direction;

FIG. 5 is a schematic plan view illustrating, in a partially enlarged manner, a state in which plural battery cells are accommodated in a module case; and

FIG. 6 is a plan view corresponding to FIG. 5, and illustrates a modified example of a method of laminating plural battery cells according to an exemplary embodiment.

### DETAILED DESCRIPTION

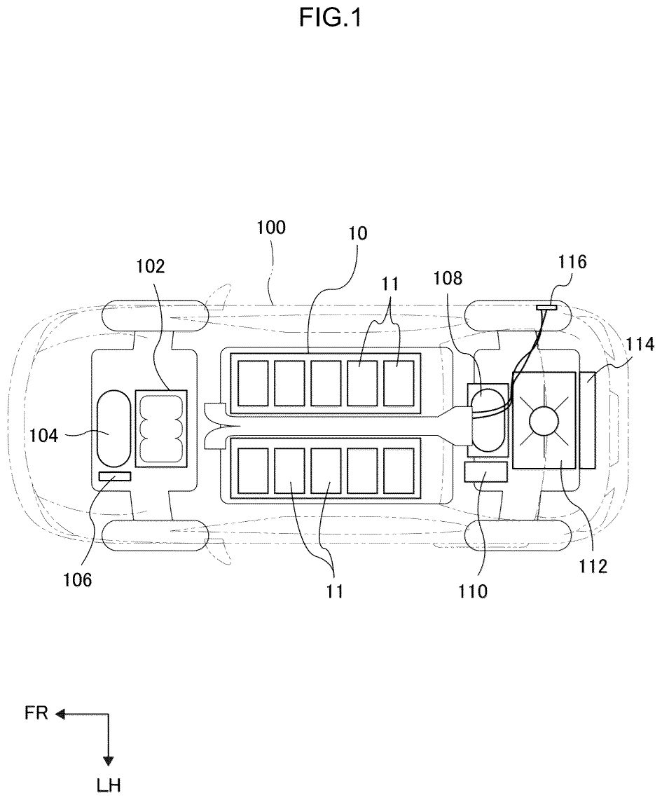

Explanation follows of an exemplary embodiment of the present disclosure with reference to FIG. 1 to FIG. 5.

### (Overall Configuration of Vehicle 100)

FIG. 1 is a schematic plan view illustrating a main part of a vehicle 100 to which a battery pack 10 according to an exemplary embodiment is applied. As illustrated in FIG. 1, the vehicle 100 is an electric vehicle (battery electric vehicle (BEV)) to which the battery pack 10 is installed under a floor. It should be noted that in each of the drawings, the arrow UP, the arrow FR, and the arrow LH respectively indicate an upper side in a vehicle up-down direction, a front side in a vehicle front-rear direction, and a left side in a vehicle width direction. Unless specifically stated otherwise, in a case in which front-rear, left-right, and up-down directions are described, these refer to the front and rear in the vehicle front-rear direction, the left and right in the vehicle width direction, and up and down in a vehicle up-down direction.

As an example, in the vehicle 100 of the present exemplary embodiment, a DC/DC converter 102, an electric compressor 104, and a positive temperature coefficient (PTC) heater 106 are arranged further to a vehicle front side than the battery pack 10. Further, a motor 108, a gear box 110, an inverter 112, and a charger 114 are arranged further to a vehicle rear side than the battery pack 10.

The DC current output from the battery pack 10 is adjusted in voltage by the DC/DC converter 102, and then supplied to the electric compressor 104, the PTC heater 106, the inverter 112, and the like. Further, by supplying electric power to the motor 108 via the inverter 112, the rear wheels rotate to cause the vehicle 100 to travel.

A charging port 116 is provided at a right side portion of a rear portion of the vehicle 100, and by connecting a charging plug of an external charging facility, which is not illustrated in the drawings, from the charging port 116, electric power can be stored in the battery pack 10 via the in-vehicle charger 114.

It should be noted that an arrangement, structure and the like of the respective components configuring the vehicle 100 are not limited to the above-described configuration. For example, the present disclosure may be applied to a hybrid vehicle (HV) installed with an engine or a plug-in hybrid vehicle (plug-in hybrid electric vehicle (PHEV)). Further, in the present exemplary embodiment, although the vehicle is a rear-wheel-drive vehicle with the motor 108 installed at a vehicle rear part, there is no limitation thereto, and the vehicle may be a front-wheel-drive vehicle with the motor 108 installed at a vehicle front part, and a pair of motors 108 may be installed at the front and rear of the vehicle. Furthermore, the vehicle may be provided with an in-wheel motor at each wheel.

Here, the battery pack 10 includes plural battery modules 11. In the present exemplary embodiment, as an example, ten battery modules 11 are provided. Specifically, five battery modules 11 are arranged in the vehicle front-rear direction at a right side of the vehicle 100, and five battery modules 11 are arranged in the vehicle front-rear direction at a left side of the vehicle 100. Further, each battery module 11 is electrically connected.

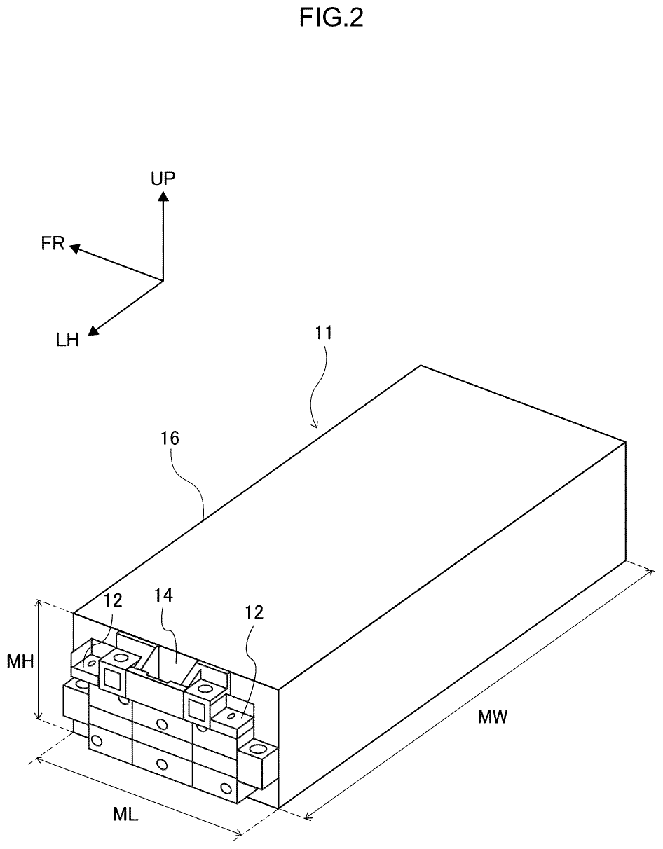

FIG. 2 is a schematic perspective view of the battery module 11. As illustrated in FIG. 2, the battery module 11 includes a module case 16 that forms an outer shell. The module case 16 is formed in a substantially rectangular parallelepiped shape having a longitudinal direction along the vehicle width direction. Further, the module case 16 is formed of an aluminum alloy. For example, the module case 16 is formed by joining aluminum die-casting to both end portions of an extruded material of an aluminum alloy by laser welding or the like.

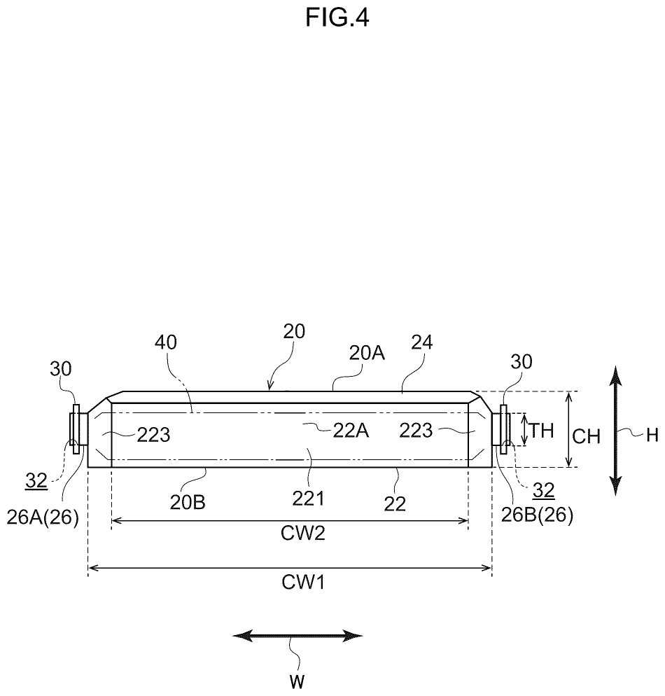

A pair of voltage terminals 12 and a connector 14 are provided at both vehicle width direction end portions of the battery module 11. A flexible printed circuit board 21, which is described below, is connected to the connector 14. Further, bus bars 30 (see FIG. 4) are welded to both vehicle width direction end portions of the battery module 11.

A length MW of the battery module 11 in the vehicle width direction is, for example, from 350 mm to 600 mm, a length ML thereof in the vehicle front-rear direction is, for example, from 150 mm to 250 mm, and a height MH thereof in the vehicle up-down direction is, for example, from 80 mm to 110 mm.

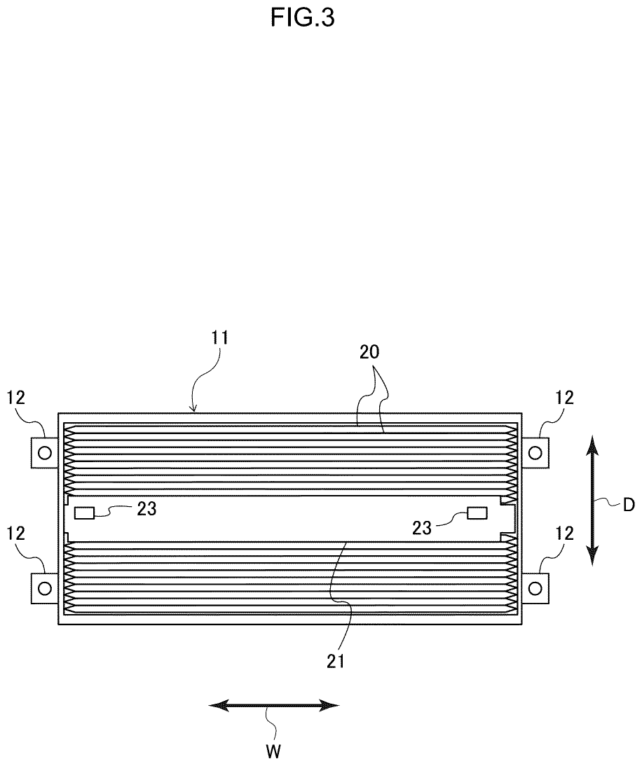

FIG. 3 is a plan view of the battery module 11 in a state in which an upper lid is removed. As illustrated in FIG. 3, as a battery, a battery cell 20 is accommodated at an interior of the module case 16. As an example, plural battery cells 20 are accommodated at the interior of the module case 16 in an arranged (laminated) state. In the present exemplary embodiment, 24 battery cells 20 are arranged in the vehicle front-rear direction and are adhered to each other.

It should be noted that for ease of explanation, in each of the drawings of FIG. 3 to FIG. 5, the direction indicated by the arrow W is defined as a width direction of the battery cell 20, the direction indicated by the arrow H is defined as a height direction (up-down direction) of the battery cell 20, and the direction indicated by the arrow D is defined as a thickness direction of the battery cell 20. The width direction of the battery case 22, which is described below, corresponds to the width direction W of the battery cell 20. The height direction of the battery case 22 corresponds to the height direction H of the battery cell 20. The thickness direction of the battery case 22 corresponds to the thickness direction D of the battery cell 20.

A flexible printed circuit (FPC) board 21 is arranged on the battery cell 20. The flexible printed circuit board 21 is formed in a band shape with a longitudinal direction thereof along the vehicle width direction, and thermistors 23 are provided at both end portions of the flexible printed circuit board 21. The thermistors 23 are not adhered to the battery cell 20 and are configured so as to be pressed toward a battery cell 20 side by the upper lid of the battery module 11.

Further, one or more cushioning materials, which are not illustrated in the drawings, are accommodated at the interior of the module case 16. For example, the cushioning material is a thin plate-shaped member that is elastically deformable, and is arranged between adjacent battery cells 20 with a thickness direction thereof along an arrangement direction of the battery cells 20. In the present exemplary embodiment, as an example, cushioning materials are respectively arranged at both longitudinal direction end portions of the module case 16 and at a longitudinal direction central portion of the module case 16.

FIG. 4 is a schematic diagram in which the battery cell 20 that is accommodated in the battery module 11 is viewed from the thickness direction D. As illustrated in FIG. 4, the battery cell 20 is formed in an elongated rectangular plate shape having a longitudinal direction along the width direction W, and includes a battery case 22 that forms an outer shell. An electrode body 40 is accommodated at an interior of the battery case 22. The electrode body 40 is configured by laminating a positive electrode as an electrode, a negative electrode as an electrode, and a separator. In the present exemplary embodiment, the battery case 22 is configured by a laminate film, and the electrode body 40 is sealed by a laminate film.

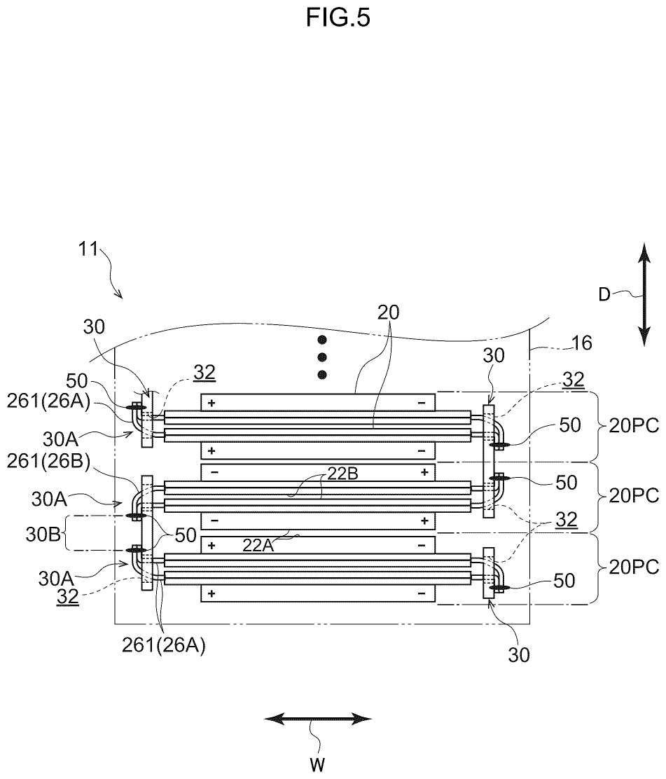

At least one side of the battery case 22 in the thickness direction of the battery case 22 is embossed. By embossing, a concave housing portion 221, the electrode body 40 being accommodated at an interior thereof, and an outer end portion 223, which is provided at an outer side of the housing portion 221, are formed at a side surface. It should be noted that although both a single-cup embossing structure in which embossing is at one location and a double-cup embossing structure in which embossing is at two locations can be adopted, in the present exemplary embodiment, the structure is a single-cup embossing structure having a draw depth of from about 8 mm to about 10 mm. Therefore, the battery case 22 has a first side surface portion 22A as an embossed surface at one side in the thickness direction of the battery case 22, and a second side surface portion 22B (see FIG. 5) as a non-embossed surface at another side in the thickness direction of the battery case 22.

The upper ends of the battery case 22 in the width direction are bent, and the corners thereof are chamfered and have a substantially trapezoidal shape. Further, the upper end portions of the battery case 22 are bent, and a fixing tape 24 is wound around the upper end portions of the battery case 22 along the width direction.

Here, the battery cell 20 includes an electrode lead 26 that protrudes from end portions of the battery cell 20 (the battery case 22) in the width direction W. Since the battery cell 20 has a single-cup embossing structure, the electrode lead 26 extends along the second side surface portion 22B, which configures the non-embossed surface of the battery cell 20.

The electrode lead 26 is configured by a positive electrode lead 26A that protrudes from one end portion of the battery cell 20 in the width direction W, and a negative electrode lead 26B that protrudes from another end portion of the battery cell 20 in the width direction W. The positive electrode lead 26A is connected to a positive electrode current collector (not illustrated in the drawings) of the electrode body 40 at the interior of the battery case 22. The negative electrode lead 26B is connected to a negative electrode current collector (not illustrated in the drawings) of the electrode body 40 at the interior of the battery case 22.

Further, as an example, the electrode lead 26 protrudes from a central position of the battery cell 20 in the height direction H. As a result, the battery cell 20 has a structure in which a position of the electrode lead 26 in the module case 16 does not change even in a case in which the orientation of the battery cell 20 is such that the left and right sides in the width direction W are reversed or even in a case in which the orientation of the battery cell 20 is such that the upper and lower sides in the height direction H are reversed.

The electrode lead 26 of each battery cell is electrically connected to a bus bar 30, which is described below, via a welded portion 50 (see FIG. 5). The electrode lead 26 is connected to an external wiring of the battery module 11 via the bus bar 30. Although a known welding method can be appropriately adopted as the welding between the electrode lead 26 and the bus bar 30, in an example of the present exemplary embodiment, the electrode lead 26 and the bus bar 30 are connected by laser welding.

A length CW1 of the battery cell 20 in the vehicle width direction is, for example, from 530 mm to 600 mm, from 600 mm to 700 mm, from 700 mm to 800 mm, from 800 mm to 900 mm, or greater than or equal to 1000 mm, a length CW2 of the region in which the electrode body is accommodated is, for example, from 500 mm to 520 mm, from 600 mm to 700 mm, from 700 mm to 800 mm, from 800 to 900 mm, or greater than or equal to 1000 mm, and a height CH of the battery cell 20 is, for example, from 80 mm to 110 mm, or from 110 mm to 140 mm. Further, a thickness of the battery cell 20 is from 5.0 mm to 7.0 mm, from 7.0 mm to 9.0 mm, or from 9.0 mm to 11.0 mm, and a height TH of the terminal 26 is from 40 mm to 50 mm, from 50 mm to 60 mm, or from 60 mm to 70 mm.

Hereinafter, for convenience of explanation, one end portion of the battery cell 20 in the height direction H is referred to as an upper end portion 20A, and another end portion of the battery cell 20 in the height direction H is referred to as a lower end portion 20B.

FIG. 5 is schematic plan view illustrating, in a partially enlarged manner, a state in which plural battery cells 20 are accommodated in the module case 16. As illustrated in FIG. 5, in the module case 16, an end portion 261 of the electrode lead 26 protrudes from an end portion of each of plural battery cells 20, which are laminated to each other, in the width direction W. Further, plural bus bars 30 are arranged at each of one side and another side of the battery cell 20 in the width direction W.

It should be noted that although FIG. 5 illustrates a state in which a space is provided between adjacent battery cells 20 for convenience of explanation, in practice, plural laminated battery cells 20 are in contact with each other via cushioning materials or are directly in contact with each other, and are restrained with each other in a state in which a predetermined restraining pressure is applied along the lamination direction (the thickness direction D).

The bus bar 30 has a plate thickness direction along the width direction W of the battery cells 20 and extends along the lamination direction (the thickness direction D) of the battery cells 20. Further, a slot-shaped through hole 32 is formed in the bus bar 30 so as to penetrate the bus bar 30 in the plate thickness direction.

The electrode lead 26, which protrudes from the end portions the battery cell 20 in the width direction W, is inserted into the through hole 32 of the bus bar 30, and the end portion 261, which protrudes from the through hole 32, is folded back toward a bus bar 30 side and superposed on a surface of the bus bar 30. The bus bar 30 is provided with a first connection portion 30A that electrically connects adjacent battery cells in parallel, and a second connection portion 30B that electrically connects two first connection portions 30A in series.

### (Method of Laminating Battery Cells)

As illustrated in FIG. 5, in the module case 16, as an example, plural laminated battery cells are electrically connected in parallel to each other to form a parallel laminated body 20PC. In the present exemplary embodiment, one parallel laminated body 20PC is configured by two adjacent battery cells.

In the parallel laminated body 20PC, the two adjacent battery cells 20 are arranged such that the second side surface portions 22B, which are non-embossed surfaces, face each other. Therefore, in the parallel laminated body 20PC, at an end portion in the width direction W, the electrode leads 26 are pulled out toward the bus bar 30 side in a state of being close to each other.

Further, in the parallel laminated body 20PC, a direction of one of the two adjacent battery cells 20 is reversed vertically in the height direction H. Therefore, the upper end portion 20A of one battery cell 20 and the lower end portion 20B of the other battery cell 20 face each other in the lamination direction (the thickness direction D in FIG. 5). For this reason, in the parallel laminated body 20PC, electrode leads having the same electrical polarity (positive electrode or negative electrode) are close to each other at one side and another side in the width direction W.

In the two electrode leads 26 that are close to each other at one side and the other side in the width direction W of the parallel laminated body 20PC, the end portions 261 that have each passed through the through hole 32 of the bus bar 30 are folded back toward the bus bar 30 side and overlap on the surface of the bus bar 30. On the surface of the bus bar 30, the overlapping portion of the two electrode leads 26 is joined by the welded portion 50.

Two parallel laminated bodies 20PCs arranged in the lamination direction are electrically connected in series via a second connection portion 30B of the bus bar 30 that extends in the lamination direction between the two parallel laminated bodies 20PCs. In other words, the second connection portion 30B electrically connects the two first connection portions 30A in series.

At a side of the second connection portion 30B, the battery cell 20 that is connected to one of the two first connection portions 30A and the battery cell 20 that is connected to another of the two first connection portions 30A are adjacent to each other. The two adjacent battery cells 20 are arranged such that the first side surface portions 22A, which are embossed surfaces, face each other. For this reason, a space corresponding to the thickness of the embossed surfaces of the two adjacent battery cells 20 is provided between the two first connection portions 30A. Therefore, the length of the bus bar 30 that configures the second connection portion 30A is set in accordance with the thickness of the embossed surfaces of the two adjacent battery cells 20.

### Operation and Effects

As described above, in the battery module 11 according to the exemplary embodiment, plural battery cells 20, which are laminated to each other, are accommodated in the module case 16. Further, plural battery cells 20 are electrically connected to each other via a bus bar 30. In the battery cells 20, the first side surface portion 22A, which is an embossed surface forming a housing space at the interior of the battery cell 20, and the planar second side surface portion 22B are arranged to face each other in the lamination direction, and have a so-called single-cup embossing structure. The battery cell 20 includes the electrode lead 26 that is provided along the second side surface portion 22B so as to protrude from the end portions of the battery cell 20 in the width direction W.

Here, the battery module 11 includes the first connection portion 30A that arranges the second side surface portions 22B of the two adjacent battery cells 20 so as to face each other, brings the electrode leads 26 of the two adjacent battery cells 20 close to each other, and is connected to the bus bar 30. In the first connection portion 30A, even in a case in which the electrode leads 26 of adjacent battery cells 20 are brought into close proximity and the length of the bus bar 30 along the lamination direction of the plural battery cells 20 is shortened, the bending angle of the electrode leads 26 toward the bus bar 30 side, to which the electrode leads 26 connect, can be reduced, whereby a stress load on the electrode leads 26 is reduced. As a result, the bus bar can be shortened, and the space efficiency in the module case can be increased, and the stress load on the electrode leads 26 can be reduced at the connection portion between an electrode tab and the bus bar.

Further, in the present exemplary embodiment, the first connection portion 30A electrically connects electrode leads 26 having the same electrical polarity to each other. That is, adjacent battery cells 20 are electrically connected in parallel via the first connection portion 30A. Therefore, at the location at which plural adjacent battery cells 20 are electrically connected to each other in parallel, the bus bar 30 can be shortened, and the stress load on the electrode leads can be reduced at the connection portion between the electrode leads 26 and the bus bar 30 while increasing the space efficiency in the module case.

Further, the present exemplary embodiment includes the second connection portion 30B that electrically connects two first connection portions 30A in series via the bus bar 30. Furthermore, between the battery cell 20 connected to one of the two first connection portions 30A and the battery cell 20 connected to the other of the two first connection portions 30A, the two adjacent battery cells 20 are arranged such that the first side surface portions 22A, which are embossed surfaces, face each other. For this reason, a space corresponding to the thickness of the embossed surfaces of the two adjacent battery cells 20 is provided between the two first connection portions 30A. Therefore, the length of the bus bar 30 that configures the second connection portion 30B can be designed in accordance with the thickness of the embossed surfaces of the two adjacent battery cells 20, whereby design can be facilitated.

In the present exemplary embodiment, the electrode lead 26 of each battery cell 20 protrudes from the end portions of the battery cell 20 in the width direction W, at the central position in the height direction H. For this reason, even in a case in which the orientation of the battery cell is such that the left and right sides in the width direction W are reversed, and even in a case in which the orientation of the battery cell is such that the upper and lower sides in the vertical direction H are reversed, the position of the electrode lead 26 in the module case 16 does not change. As a result, for example, in a case in which two electrode leads 26 having different electrical polarities are brought close to each other and connected to the bus bar 30, a direction of one of the two adjacent battery cells 20 may be reversed to the left and right in the width direction W, and the second side surface portions 22B of the two adjacent battery cells 20 may face each other. Further, for example, in a case in which two electrode leads 26 having the same electrical polarity are brought close to each other and connected to the bus bar 30, a direction of one of the two adjacent battery cells 20 may be reversed vertically in the height direction H, and the second side surface portions 22B of the two adjacent battery cells 20 may face each other. In other words, in the present exemplary embodiment, the direction of the battery cells 20 can be freely changed in the module case 16, whereby plural battery cells 20 can be connected to each other in a manner with high space efficiency. As a result, the battery module 11 has a highly versatile structure, and design modification thereof in consideration of the space efficiency in the module case 16 is easy.

Although one exemplary embodiment has been described above, the present disclosure can be implemented with various modifications without departing from the gist thereof. Obviously, the scope of rights of the present disclosure is not limited to the above-described embodiment. Explanation follows of a modified example that can be substituted or combined with the configuration of the above-described exemplary embodiment.

### (Modified Example of Method of Laminating Battery Cells)

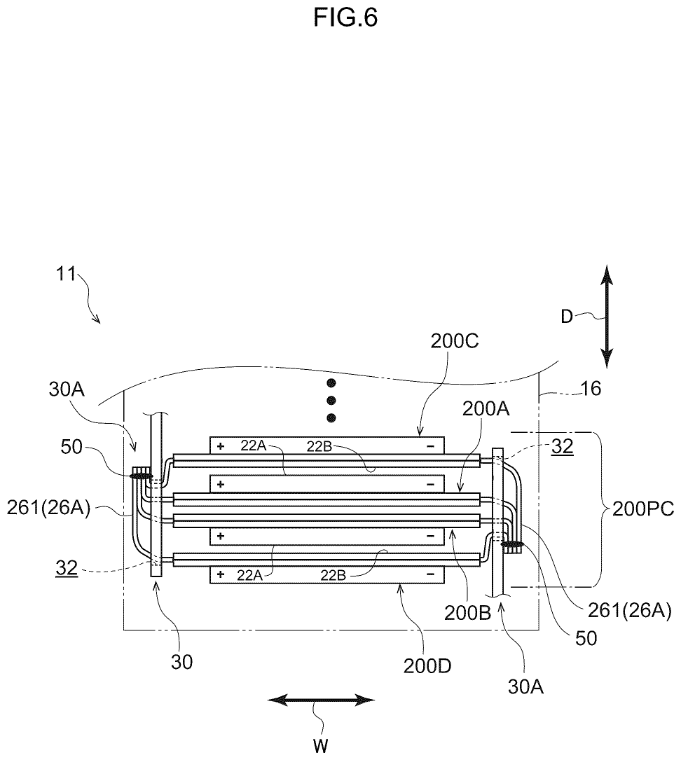

In the above-described exemplary embodiment, although two adjacent battery cells 20 are electrically connected in parallel via the first connection portion 30A, as illustrated in FIG. 6, three or more battery cells 20 may be electrically connected in parallel via the first connection portion 30A.

In FIG. 6, a first battery cell 201, a second battery cell 202, a third battery cell 203, and a fourth battery cell 204 are electrically connected in parallel via the first connection portion 30A to form a parallel laminated body 200PC. It should be noted that since the configurations of the first battery cell 201 to the fourth battery cell 204 are the same as those of the battery cell 20 of the above-described exemplary embodiment, the same components are denoted by the same reference numerals, and detailed descriptions thereof are omitted.

The first battery cell 201 and the second battery cell 202 are adjacent to each other in the lamination direction (the thickness direction D in FIG. 6). The first battery cell 201 and the second battery cell 202 are arranged such that the second side surface portions 22B, which are non-embossed surfaces, face each other. Further, the second battery cell 202 is arranged in an orientation in which up and down in the height direction H is reversed with respect to the first battery cell 201.

The third battery cell 203 is arranged adjacent to the first battery cell 201. In the third battery cell 203, the second side surface portion 22B, which is a non-embossed surface, is arranged so as to face the first side surface portion 22A, which is an embossed surface, of the first battery cell 201. The fourth battery cell 204 is arranged adjacent to the second battery cell 202. In the fourth battery cell 204, the second side surface portion 22B, which is a non-embossed surface, is arranged so as to face the first side surface portion 22A, which is an embossed surface, of the second battery cell 202.

In the above-described parallel laminated body 200PC, at the location at which plural adjacent battery cells 20 are electrically connected to each other in parallel, the length of the bus bar 30 can be shortened while reducing the stress load on the electrode leads 26.

Further, in the above-described embodiment, although two adjacent battery cells 20 are electrically connected in parallel via the first connection portion 30A, the present disclosure is not limited thereto. Two adjacent battery cells 20 may be electrically connected in series via the first connection portion 30A. That is, two electrode leads 26 having different electrical polarities may be brought close to each other, and adjacent battery cells 20 may be electrically connected to each other in series.

What is claimed is:

1. A battery module in which a plurality of battery cells that are laminated to each other are accommodated inside a module case, and the plurality of battery cells are electrically connected to each other via a bus bar, wherein:
each battery cell includes a first side surface portion that is an embossed surface forming a housing space at an interior of the battery cell, and a planar second side surface portion, which are arranged so as to face each other in a lamination direction, and an electrode lead is provided along the second side surface portion and protrudes from width direction end portions of the battery cell, and
the battery module comprises at least one first connection portion that arranges second side surface portions of two adjacent battery cells so as to face each other, brings electrode leads of the two adjacent battery cells close to each other, and is connected to the bus bar.

2. The battery module according to claim 1, wherein:
the at least one first connection portion brings electrode leads having a same electrical polarity close to each other and electrically connects the two adjacent battery cells in parallel.

3. The battery module according to claim 2, wherein:
the battery module comprises at least one second connection portion that electrically connects two first connection portions in series via the bus bar, and
between a battery cell that is connected to one of the two first connection portions and a battery cell that is connected to another of the two first connection portions, the two adjacent battery cells are arranged such that first side surface portions face each other.

4. The battery module according to claim 1, wherein:
the electrode lead protrudes from a height direction central portion of the battery cell.
